(19) United States
(12) Patent Application Publication
(10) Pub. No.: US 2013/0156271 A1
(43) Pub. Date: Jun. 20, 2013

(54) SYSTEM FOR ANALYSIS OF PESTS AND DISEASES IN CROPS AND ORCHARDS VIA MOBILE PHONE

(71) Applicant: Net-Fit Tecnologia Da Informacao Ltda., Sao Paulo (BR)

(72) Inventor: Flavio Junqueira CIMINO, Sao Paulo (BR)

(73) Assignee: Net-Fit Tecnologia Da Informacao Ltda., Sao Paulo (BR)

(21) Appl. No.: 13/721,828

(22) Filed: Dec. 20, 2012

(30) Foreign Application Priority Data
Dec. 20, 2011 (BR) PI1106965-1
Oct. 9, 2012 (BR) BR1320120257881

(51) Int. Cl. G06K 9/00

(52) U.S. Cl. CPC G06K 9/00624
USPC 382/110

(57) ABSTRACT

System for analysis of pests and diseases in crops and orchards via mobile phone refers essentially to a system that uses a mobile phone (3) as an enabler way, using it in loco or in a unmanned aircraft (A), with access to internet (6), camera (2), GPS (4) and image processing computer program (5), which is sent to a central server (7); a software performs the recognition (8) of the captured image and other software extracts (10) and analyzes the photographed pest or disease by comparison with a specific database (9), sending then the compiled and tabulated information (11) back to the mobile phone (3) of the system user.

### CROSS-REFERENCE TO RELATED APPLICATIONS

This application claims priority from Brazilian Application Serial No. BR1320120257881, filed on Oct. 9, 2012 and Brazilian Patent No. PI 1106965-1, filed on Dec. 20, 2011, the entire contents of which are herein incorporated by reference.

### INTRODUCTION

This Patent of Invention relates to a new system for analysis of pests and diseases in crops and orchards via mobile phone, specially of a system made possible through mobile phone, operated in loco or unmanned aircraft, with a specific software for image processing and another for tabulation, which are used for making the analysis of pests and diseases in crops and orchards, by recording a digital image of the affected place, which, digitally treated, is compared with other images in a central database, for further analysis and diagnosis, being sent back to the mobile phone device in text format.

It is known that extensive farming has the negative aspect of favoring the appearance of numerous pests and diseases, with enough potential to decimate large areas, which compromises the productivity of that crop. The farmer, to minimize the damage, is forced to use increasingly amounts and/or types of pesticides, since with time infector agents become resistant.

It is also an aggravating factor the dependence of human observation and analysis for determining the pest or disease, subject to error as regards the degree of infestation, o that may lead to the excessive application of pesticides in places where it would not be necessary and vice versa.

Currently, in the crops and orchards, inspection of pests and diseases is performed by sampling and visually by groups of workers, with the data being directed to specialists which deal with proper guidance on the application of pesticides.

This kind of inspection does not seem reliable, being due the inability and/or negligence of workers and/or due to the difficulty in measuring, controlling and checking the information getting from the field.

Thus, all inconveniences generate total insecurity among farmers and low efficiency in spraying, which, in practice, requires increasing the frequency of pesticides applications and its costs, as well as environmental impact, resulting from the excess of agrochemicals released to the environment.

The current prior art anticipates some documents that deal with forms and means to enable monitoring of pests, as, for instance, the Brazilian patent PI 9708884-6 “Métodos and Aparelho para o Monitoramento or Controle de Pragas”. A method and device to monitor and control pests typically in a position above ground, as social harmful insects, which live in colonies and communicate through chemical signals, such as termites. An comestible array for the pest are included, a plurality of interchangeable housing, each defining an internal chamber, capable of containing the matrix, means for connecting (and removing) each of the housings to at least one other of the housings, since the inner chambers are disposed in communication with one another through holes defined in the housings, means for mounting at least one of the housings to a mounting surface next to the pests, so that the housings can be detached from each other, rearranged, deleted, supplemented, and reassembled, while the matrices are provided within an environment that has a relatively restricted air movement and controlled evaporation of moisture.

The document above mentioned, although improve analysis, is limited to certain pests, being both constructiveness and handling complex and/or toilsome, besides the result will require a great time, due to the physical sending of information/devices to the places where the analysis will be made. This time can be substantially detrimental with regard to the immediate combat that should be performed in more aggressive pests.

Aware of prior art, their gaps and limitations, the inventor, a person skilled in this subject-matter, after numerous researches and studies, has created this new system for analysis of pests and diseases in crops and orchards via mobile phone, which uses a remote hardware with internet access, being better represented by a mobile phone, having a digital camera, GPS (Global Position System), computer program for processing of image, which is sent to a central server, a software developed for image recognition itself, and another software for extraction and tabulation of data, thus making the analysis, and being available to be sent to the concerned people all information related to that pest or disease. The mobile phone enabler of the system can be used in loco, which means in the crop or orchard themselves or in a wider capture, with its coupling in an unmanned aircraft.

In short, the pledged system has as the more prevalent advantages:

Elimination of visual analysis to identify the pests and diseases, increasing the reliability of the producer and the optimization of spraying;

Versatility—possibility of use on ground, which means in the crop itself or with air capture, in the case of installation on unmanned aircraft;

Minor environmental impact opposed to the over dimensioned spraying, in theory, of the conventional systems;

Small learning curve of the system, since the use of mobile phone devices and their computer programs are already well diffused;

Less chance of negligence caused by an employee—in the known systems, it is common a person to provide random information without ever having been on the place (it no longer occur, because the image is associated with location information provided by GPS);

Ability to take countermeasures in real time—with the information generated from the digital image capture, analysis is performed immediately;

The system can be applied in mobile phones from any manufacturer or model, since they are provided with minimal configuration already explained.

### BRIEF DESCRIPTION OF THE DRAWINGS

To follow, this invention is explained with reference to the drawings related below, in an illustrative and not limitative way:

FIG. 01: Schematic view of system for analysis of pests and diseases in crops and orchards via mobile phone;

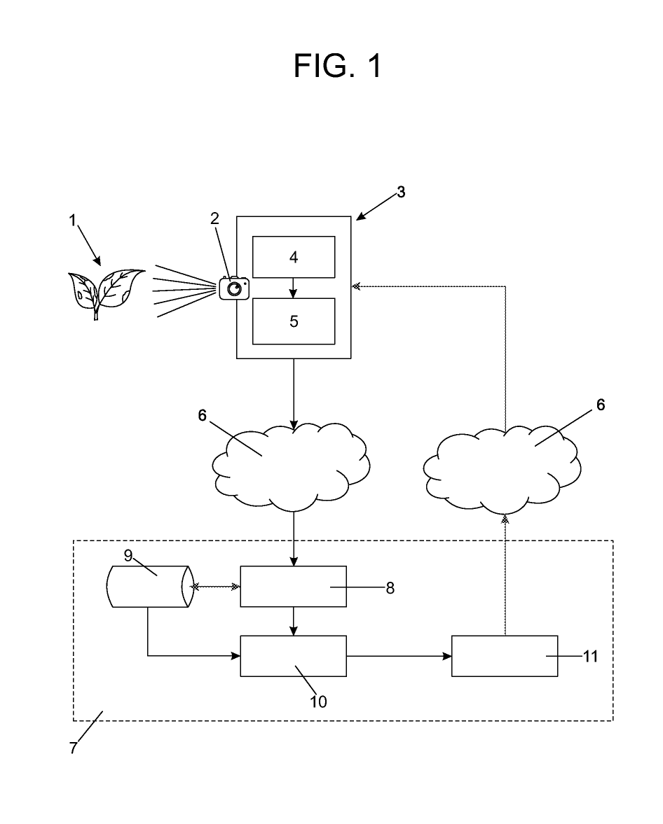

FIG. 02: Schematic view of system for analysis of pests and diseases in crops and orchards via mobile phone, showing a condition of use in loco;

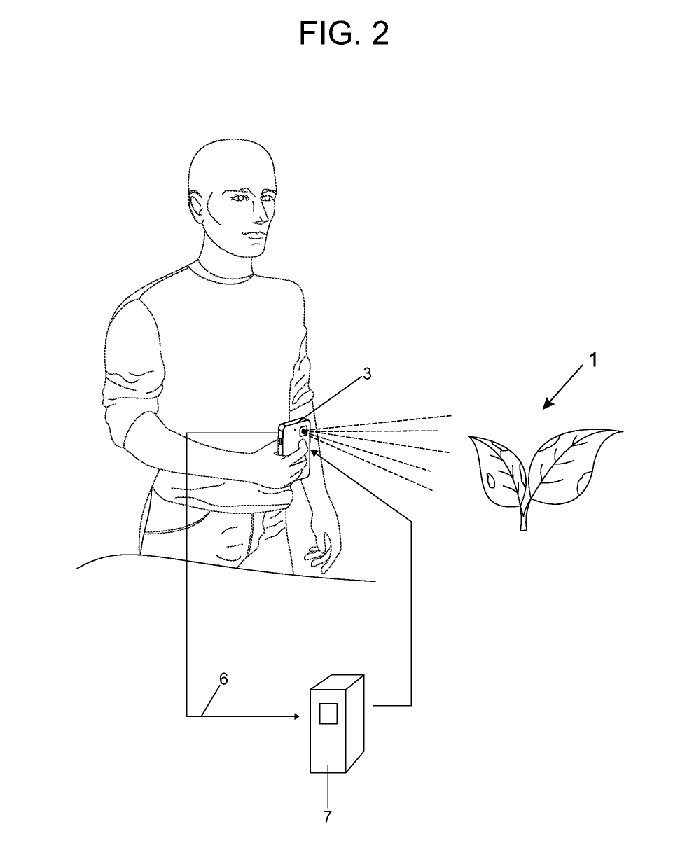

FIG. 03: Schematic view of system for analysis of pests and diseases in crops and orchards via mobile phone, showing a condition of use in unmanned aircraft.

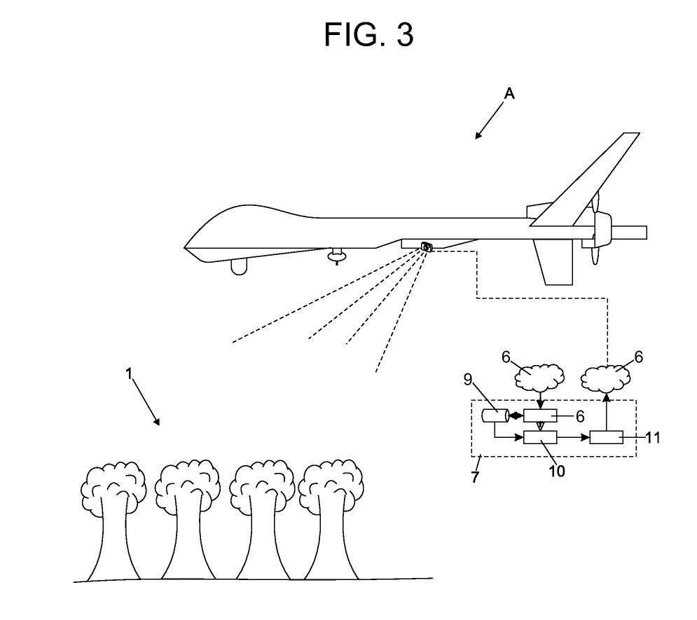

The system for analysis of pests and diseases in crops and orchards via mobile phone, object of this patent of invention request, essentially consists of a system that uses as an enabler means, as mobile phone (3) device in loco or in unmanned aircraft (A), with internet access (6), camera (2), GPS and image processing computer program (5), which is sent to a central server (7); a software performs the recognition (8) of the captured image and other software extracts (10) and analyzes the photographed pest or disease by comparison with a specific database (9), sending then the compiled and tabulated information (11) back to the mobile phone (3) of the system user.

More particularly, the pledged system has as hardware a mobile phone (3), used in loco or in unmanned aircraft (A), starting with the registration, through the camera (2) of said mobile phone (3), of the crop (1) or affected place, focusing on the problem at hand. When the image is captured (4), the mobile phone itself defines the date, hour, and its global positioning, using the coordinates of GPS, which ensures the authenticity of the record. A computer program (5) processes the image, which is then sent via internet (6), rather 3G, to a central server (7), in which an image recognition software (8) and other software for information extraction (10), by comparison of the image with a database (9) with numerous images of cataloged pests and diseases, makes analysis and deliver technical strategic and operational guidance that are returned to the mobile phone (3) from user via internet (6), in text form and/or compiled and tabulated charts (11) through the same software.

The same concept can be applied when installing mobile phone (3) in an unmanned aircraft (A), in this case, it is capable to make a more comprehensive sweep.

The information is varied, as, for instance, the kind of pest or disease, products for combat, dosage, frequency, among others. The return of the information can also feed other computer systems, aiming other types of services that rely on such information.

1. System for analysis of pests and diseases in crops and orchards via mobile phone, wherein it starts with registration of the crop (1) or affected location through camera (2) of the mobile phone (3); on the image capture (4), they are already set date, time and its positioning; a computer program (5) processes the image, which is sent to a central server (7) through internet (6); it comprises further a recognition software (8) of image and other software of information extraction (10); the photo is then compared with a database (9) with countless images of catalogued pests and diseases, performing the analysis and sending strategic and operational technical guidelines, which come back to the mobile phone (3) of the user via internet (6), in text form and/or compiled and tabulated charts (11) through the software.

2. System for analysis of pests and diseases in crops and orchards via mobile phone, according to claim 1, wherein the use of the mobile phone (3) can be made in loco or fixed to an unmanned aircraft (A).

3. System for analysis of pests and diseases in crops and orchards via mobile phone, according to claim 1, wherein the image is set with date and time and it is situated in the space through GPS coordinates already embedded in the mobile phone.

4. System for analysis of pests and diseases in crops and orchards via mobile phone, according to claim 1, wherein information are varied, as type of pest or disease, products for their extermination, dosage, frequency, among others.

5. System for analysis of pests and diseases in crops and orchards via mobile phone, according to claim 1, wherein information can feed other computerized systems.
